(19) United States
(12) Patent Application Publication
(10) Pub. No.: US 2014/0190455 A1
(43) Pub. Date: Jul. 10, 2014

(54) HYBRID DRIVE DEVICE

(71) Applicant: Takeshi Ootsuki, Anjo (JP)

(72) Inventor: Takeshi Ootsuki, Anjo (JP)

(73) Assignee: AISIN AW CO., LTD., Anjo-shi, Aichi-ken (JP)

(21) Appl. No.: 14/238,668

(22) PCT Filed: Sep. 12, 2012
(86) PCT No.: PCT/JP2012/073306

§ 371 Date: Feb. 12, 2014

(30) Foreign Application Priority Data
Oct. 31, 2011 (JP) 2011-239710

(51) Int. Cl. F02D 41/32

(52) U.S. Cl. CPC F02D 41/32
USPC 123/497

(57) ABSTRACT

A hybrid drive having a hydraulic control device capable of hydraulically controlling a first clutch, a second clutch, and a continuously variable transmission using a hydraulic pressure generated by at least one of a mechanical oil pump and an electric oil pump. A control section is configured to execute a mechanical oil pump drive mode in which a command to start an internal combustion engine is provided to drive the mechanical oil pump via a first shaft using output rotation of the internal combustion engine during reverse travel in which reverse rotation is output from the rotary electric machine to rotate wheels in reverse via the second shaft, the second clutch, and the continuously variable transmission with the first clutch disengaged and with the second clutch engaged by providing a command to the hydraulic control device.

### FIELD

The present invention relates to a hybrid drive device mounted on a vehicle or the like, and in particulars to a hybrid drive device that includes a mechanical oil pump driven in conjunction with an internal combustion engine and an electric oil pump driven independently of the mechanical oil pump and that hydraulically controls a continuously variable transmission on the basis of a hydraulic pressure from the oil pumps.

### BACKGROUND ART

In recent years, in order to improve the fuel efficiency of vehicles, there are proposed a variety of hybrid drive devices mounted on a vehicle or the like. Among others, there are proposed a hybrid drive device with a simple structure in which one motor is disposed between an internal combustion engine and a continuously variable transmission (see Patent Document 1). In general, a continuously variable transmission of a belt type or the like that varies the speed of rotation of an internal combustion, engine includes a forward/reverse travel switching device that enables reverse travel by reversing input rotation, because it is difficult for the internal combustion engine to output reverse rotation. In the hybrid drive device according to Patent Document 1, however, a motor outputs reverse rotation to enable reverse travel. This eliminates the need to reverse the rotation of the internal combustion engine, that is, allows adopting a structure in which a forward/reverse travel switching device is omitted.

### RELATED ART DOCUMENTS

### [Patent Documents]

[Patent Document 1] Japanese Patent Application Publication No. 2001-260672 (JP 2001-260672 A)

### SUMMARY OF THE INVENTION

### [Problem to be Solved by the Invention]

In the hybrid drive device including the continuously variable transmission (CVT) of the belt type or the like such as that according to Patent Document 1 described above, a relatively high belt holding pressure that can even resist the maximum output torque of the internal combustion engine is required to suppress occurrence of slip or the like of the belt of the continuously variable transmission.

If all the hydraulic pressure required for the continuously variable transmission is to be provided by an electric oil pump, it is necessary to adopt a large and expensive electric oil pump, which is unfavorable. Therefore, a mechanical oil pump driven in conjunction with the internal combustion engine is provided so that the mechanical oil pump outputs a belt holding pressure that is enough to even resist the maximum output torque of the internal combustion engine during forward travel. This makes the electric oil pump auxiliary, and allows adopting a compact and inexpensive structure as a whole.

If reverse travel (EV travel) is to be performed using output of the motor as discussed above, a belt holding pressure that can resist the maximum output of the motor is required. For EV travel in which the internal combustion engine is stopped, however, it is necessary that all the hydraulic pressure (belt holding pressure) should be provided by the electric oil pump, which hinders downsizing and cost reduction of the electric oil pump.

It is therefore an object of the present invention to provide a hybrid drive device that enables downsizing and cost reduction of an electric oil pump by reducing the size of the electric oil pump by reducing a required hydraulic pressure to he output from the electric oil pump during reverse travel in which a rotary electric machine outputs reverse rotation to rotate wheels rearward.

### [Means for Solving the Problem]

A hybrid drive device (1) according to the present invention (see FIGS. 1 to 5, for example) is characterized by including:
a first shaft (11) drivably coupled to an internal combustion engine (2);
a mechanical oil pump (21) driven in conjunction with the first shaft (11);
an electric oil pump (22) driven independently of the mechanical oil pump (21);
a rotary electric machine (3):
a second shaft (12) drivably coupled to the rotary electric, machine (3);
a first clutch (K0) capable of blocking power transfer between the first shaft (11) and the second shaft (12):
a continuously variable transmission (4) capable of continuously varying to speed of rotation input to an input shaft (4a) and outputting Output to wheels (30) rotation in the same direction as a direction of the rotation input to the input shaft (4a);
a second clutch (C1) capable of blocking power transfer between the second shaft (12) and the input shaft (4a);
a hydraulic control device (9) capable of hydraulically controlling the first clutch (K0), the second clutch (C1), and the continuously variable transmission (4) using a hydraulic pressure generated by at least one of the mechanical oil pump (21) and the electric oil pump (22); and
a control section (50) capable of executing to mechanical oil pump drive mode in which a command to start the internal combustion engine (2) is provided to drive the mechanical oil pump (21) via the first shaft (11) using output rotation (for example, ω1) of the internal combustion engine (2) doting reverse travel in which reverse rotation (for example, ω2) is output from the rotary electric machine (3) to rotate the wheels (30) in reverse via the second shaft (12), the second clutch (C1), and the continuously variable transmission (4) with the first clutch (K0) disengaged and with the second clutch (C1) engaged by providing a command to the hydraulic control device (9).

With such a configuration, in the hybrid drive device which performs reverse travel using reverse rotation from the rotary electric machine, the mechanical oil pump drive mode in which the mechanical oil pump is driven using output rotation of the internal combustion engine can be executed. Thus, a hydraulic pressure can be generated by drive or the mechanical oil pump even during reverse travel. This reduces the design required hydraulic pressure to be output from the electric oil pump, which enables size reduction and cost reduction or the electric oil pump. This enables downsizing and cost reduction or the hybrid drive device.

In addition, the control section (50) of the hybrid drive device (1) according to the present invention (see FIG. 1, for example) may execute the mechanical oil pump drive mode in the case where input torque input to the continuously variable transmission (4) is equal to or more than a predetermined value (TA).

With such a configuration, the mechanical oil pump drive mode is executed in the case where the input torque input to the continuously variable transmission is equal to or more than the predetermined torque. Thus, in the case where the hydraulic pressure that is required for the continuously variable transmission (for example, the belt, holding pressure) is lower than a predetermined pressure, as hydraulic pressure is supplied by drive of the electric oil pump, which makes it possible to stop the internal combustion engine and to improve the fuel efficiency of the vehicle. In the case were the hydraulic pressure that is required for the continuously variable transmission (for example, the belt holding pressure) is higher than a predetermined pressure, meanwhile, the required hydraulic pressure can be secured by drive of the mechanical oil pump driven by the internal combustion engine.

Further, the control section (50) of the hybrid drive device (1) according to the present invention (see FIGS. 1 and 5, for example) may be capable of executing a charge mode in which charge is performed by driving the rotary electric machine (3) via the first shaft (11), the first clutch (K0), and the second shaft (12) using output rotation (for example, ω1) of the internal combustion engine (2) with the first clutch (K0) engaged and with the second clutch (C1) disengaged by providing a command to the hydraulic control device (9).

With such a configuration the charge mode in which charge is performed by driving the rotary electric machine using output rotation of the internal combustion engine with the first clutch engaged and with the second clutch disengaged can be executed. This allows charging to be performed while the vehicle is stationary (without traveling forward) even if the remaining charge capacity is short of a level that is required for reverse travel, which makes it possible to resume reverse travel.

The symbols in the above parentheses are provided for reference to the drawings. Such symbol are provided for convenience to facilitate understanding of the present invention, and should not he construed as affecting the scope of the claims in any way.

### BRIEF DESCRIPTION OF THE DRAWINGS

FIG. 1 is a block diagram illustrating a drive system of a vehicle on which a hybrid drive device according to the present invention is mounted.

FIG. 2 illustrates the power transfer state in the hybrid drive device, in which FIG. 2A corresponds to a forward travel mode by an internal combustion engine and FIG. 2B corresponds to a forward travel mode by a motor.

FIG. 3 illustrates the power transfer state in the hybrid drive device, in which FIG. 3A corresponds to a reverse travel mode with torque less than predetermined torque and FIG. 2B corresponds to a reverse travel mode with torque equal to or more than the predetermined torque.

FIG. 4 is a flowchart illustrating control during reverse travel.

FIG. 5 illustrates the power transfer state in the hybrid drive, device in a charge mode.

### MODES FOR CARRYING OUT THE INVENTION

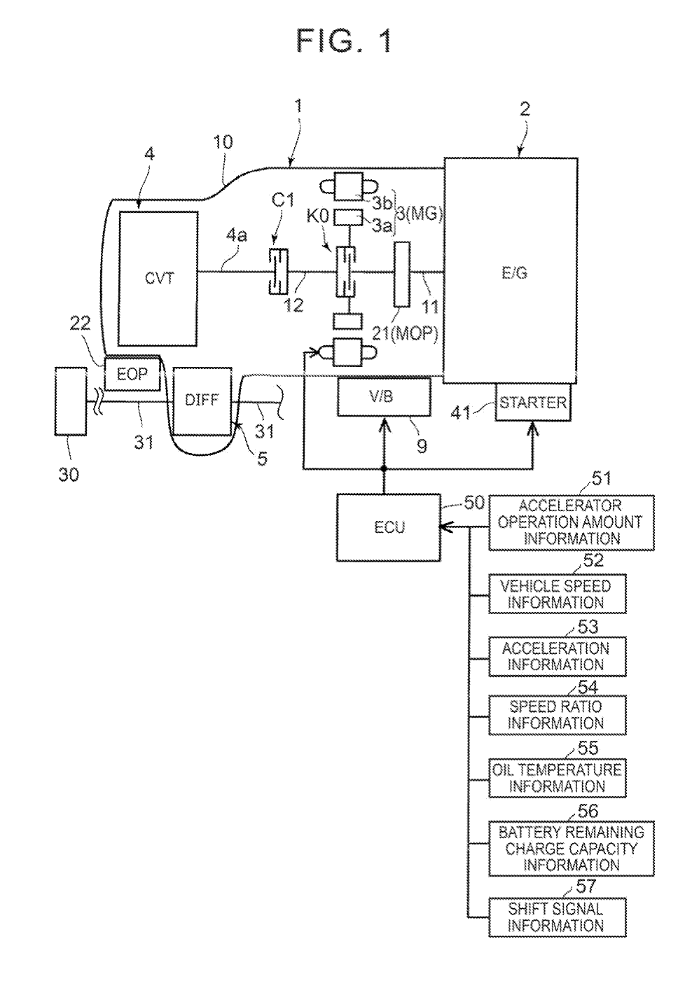

An embodiment of the present invention will be described below with reference to FIGS. 1 to 5. First, a schematic configuration of a hybrid drive device to which the present invention can be applied and a drive system of a vehicle on which the hybrid drive device is mounted will be described with reference to FIG. 1.

As illustrated in FIG. 1, a vehicle of an FF (front engine from drive) type includes an internal combustion engine (E/G) 2 mounted with an output shaft (crankshaft) (not illustrated) disposed transversely with respect to the travel direction of the vehicle. An input shaft (first shaft) 11 of a hybrid drive device 1 according to the present invention is drivably coupled to the output shaft of the internal combustion engine 2. Left and right axes 31, 31 for front wheels are drivably coupled to a differential device (DIFF) 5 of the hybrid drive device 1. Left and right front wheels 30 are connected to the left and right axes 31, 31. A starter (STARTER) 41 for starting the internal combustion engine 2 which is stopped is connected to the internal combustion engine 2.

The hybrid drive device 1 constitutes a part of a vehicle drive system that extends from the internal combustion engine 2 to the tell and right from wheels 90, 90 described above. The hybrid drive device 1 includes the input shaft 11, a first clutch K0 for engine disconnection, a motor generator (M/G) (rotary electric machine) 3, an intermediate shaft (second shaft) 12, a second clutch C1 for motor generator disconnection, a continuously variable transmission (CVT) 4 of a belt type, and the differential device (DIFF) 5, which are provided inside a ease 10. The hybrid drive device 1 also includes an electric oil pump 22, a hydraulic control device (V/B) 9, a control section (ECU) 50, and so forth, which are provided outside the case 10.

More particularly, in the hybrid drive device 1, the input shaft 11 (of the hybrid drive device) is drivably coupled to the output shaft (not illustrated) of the internal combustion engine 2. A mechanical oil pump (MOP) 21 that is an oil pump of a gear type, for example, is disposed on the input shaft 11. A drive gear (not illustrated) of the mechanical oil pump 21 is drivably coupled to the input shaft 11. That is, the mechanical oil pump 21 is driven in conjunction with the input shaft 11. In other words, the mechanical oil pump 21 is driven in conjunction with the internal combustion engine 2. When driven, the mechanical oil pump 21 sucks oil from an oil pan (not illustrated.), and supplies a hydraulic pressure as a source pressure for the hydraulic control device 9.

The first clutch K0 for engine disconnection which is capable of blocking power transfer between the input shaft 11 and the intermediate shaft 12 described above is provided between the input shaft 11 and the intermediate shaft 12.

The first clutch K0 includes a hydraulic servo (not illustrated). The hydraulic servo is drivably controlled by a hydraulic pressure supplied from the hydraulic control device 9 on the basis of a command from the control section 50 to control engagement and disengagement of the first clutch K0.

Meanwhile, the motor generator (M/G) (hereinafter referred to simply a “motor”) includes a rotor 3a and a stator 3b fixed with respect to the case 10. The rotor 3a of the motor 3 is drivably coupled to a clutch drum, which is an output-side member of the first clutch K0. The clutch drum of the first clutch K0 is also drivably coupled to the intermediate shaft 12. That is, the intermediate shaft 12 is drivably coupled to the motor 3.

The second clutch C1 for motor generator disconnection which is capable of blocking power transfer between the intermediate shaft 12 described above and an input shaft 4a of the continuously variable transmission 4 to he discussed in detail later is provided between the intermediate shaft and the input shaft 4a. As with the first clutch K0, the second clutch C1 includes a hydraulic servo (not illustrated). The hydraulic servo is drivably controlled by a hydraulic pressure supplied from the hydraulic control device 9 on the basis of a command fm the control section 50 to control engagement and disengagement of the second clutch C1.

The continuously variable transmission (CVT) 4 is constituted from continuously variable transmission of a so-called belt type, and includes a primary pulley, a secondary pulley, and a belt wound around the pulleys (not illustrated). The continuously variable transmission 4 continuously varies the speed of rotation input to the it put shaft 4a, and outputs rotation in the same direction as the direction of the rotation input to the input shaft 4a to the wheels 30 via a counter gear (not illustrated) and the differential device (DIFF) 5 and the left and right axes 31, 31 discussed above. In short, the continuously variable transmission 4 does not include a forward/reverse travel switching device that switches the rotation input to the input shaft 4a between forward rotation and reverse rotation, and the direction of the output rotation is the same as the direction of the rotation input to the input shall 4a. That is, the continuously variable transmission 4 is a transmission that only continuously varies the speed of the rotation input to the input shaft 4a in the same rotational direction.

The primary pulley and the secondary pulley of the continuously variable transmission 4 are constituted from a movable pulley and a stationary pulley, for example, with a chamber provided on the back surface side of the movable pulley. A hydraulic pressure is supplied from the hydraulic control device 9 to the chamber to control the pressure for holding the belt, That is when the continuously variable transmission 4 transfers relatively small torque, the hydraulic pressure supplied to the chamber is reduced to improve the durability of the belt. When the continuously variable transmission 4 transfers relatively large torque, meanwhile, the hydraulic pressure supplied to the chamber is increased to bold the belt with a high holding pressure so that the belt does not slip. Thus, when large torque is input from the internal combustion engine 2 or the motor 3 and a large torque capacity is required as the transfer torque capacity of the continuously variable transmission 4, it is necessary to supply a high hydraulic pressure from the hydraulic control device 9 to the chamber, and it is necessary that the hydraulic control device 9 should obtain a high hydraulic pressure from the mechanical oil pump 21 or the electric oil pump 22 to be discussed later as the source pressure.

The electric oil pump 22 is attached outside the case 10 (or may be disposed inside the case 10 as a matter of course), for example, and driven by an electric motor (not illustrated) to be driven independently of the mechanical oil pump 21 irrespective of drive of the internal combustion engine 2, the motor 3, or the like. That is, the electric oil pump 22 independently accessorily generates a hydraulic pressure while the mechanical oil pump 21 is stopped with the internal combustion engine 2 stopped, and secures the supply of the source pressure to the hydraulic control device 9 even during EV travel by the motor 3.

The control section 50 can start the internal combustion engine 2 by providing a command to the starter 41 described above, can control the drive force of the motor 3 by providing a command to the motor 3, and controls engagement and disengagement of the first clutch K0 described above, controls engagement and disengagement of the second clutch C1 described above, and controls shifting of the continuously variable transmission 4 described above (including control of the belt holding pressure) by providing a command to the hydraulic control device 9 for electronic control. In addition, the control section 50 controls execution of various modes such as a mechanical oil pump drive mode and a charge mode according to the present invention as discussed in detail later.

Accelerator operation amount information 51, vehicle speed information 52, acceleration information 53 for the vehicle, speed ratio information 54 for the continuously variable transmission 4, oil temperature information 55 for the hybrid drive device 1 battery remaining charge capacity information 56, a Shift signal 57, and so forth, which are the sensing results of various sensors, are input to the control section 50. The control section 50 provides a command liar output torque to the motor 3 on the basis of the information 51 to 57 to drivably control the motor 3.

That is, when input torque (that is, the drive three of the motor 3) input to the continuously variable transmission 4 during a reverse travel mode to be discussed in detail later becomes equal to or more than a predetermined value on the basis of the command provided to the motor 3, the control section 50 executes the mechanical oil pump drive mode. In the embodiment, the control section 50 of the hybrid drive device 1 is conveniently described as controlling starting (driving state) of the internal combustion engine 2. However, a control section exclusively for the engine (E/G ECU) may be separately provided.

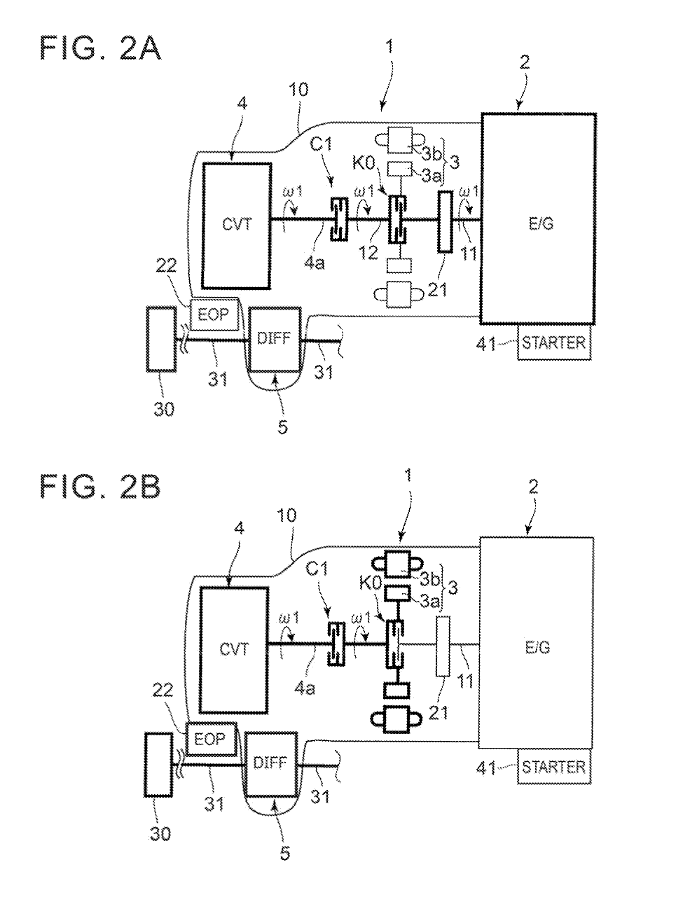

Then, the various modes of the hybrid drive device 1 will be described with reference to FIGS. 2 to 5. The control section 50 of the hybrid drive device 1 selects the various modes on the basis of the vehicle travel condition such as the shift signal 57 (that is, a drive range, a reverse range, a neutral range, and so forth), the battery remaining charge capacity (SOC) information 56, the accelerator operation amount information 51, the vehicle speed information 52, and so forth.

First, the mode during forward travel will be described with reference to FIG. 2. When the shift signal 57 indicates the drive (D) range and the accelerator operation amount is large, that is, a large drive force is required for the vehicle by a driver, for example, a “forward travel mode by the internal combustion engine 2” is selected to control the internal combustion engine 2 into a driving state and control the first clutch K0 and the second clutch C1 into an engaged state as illustrated in FIG. 2A.

That is, output rotation of the internal combustion engine 2 in the forward direction ω1 is input to the input shaft 11 or the hybrid drive device 1 drive rotation of the internal combustion engine 2 in the forward direction ω1 is also transferred to the intermediate shaft 12 via the first clutch K0, and further, drive rotation of the internal combustion engine 2 in the forward direction ω1 is transferred to the input shaft 4a of the continuously variable transmission 4 via the second clutch C1. Then, the rotation of the internal combustion engine 2 input to the input shaft 4a of the continuously variable transmission 4 is varied in speed by the continuously variable transmission 4, which is controlled so as to have a speed ratio that optimizes the fuel efficiency of the internal combustion engine 2 on the basis of the vehicle speed and the accelerator operation amount, and transferred to the wheels 30 via the differential device 5 and the left and right axes 31, 31 to rotate the wheels 30 forward.

In the “forward travel mode by the internal combustion engine 2”, the input shaft 11 is driven using output rotation of the internal combustion engine 2 to rotationally drive the mechanical oil pump 21, and therefore a hydraulic pressure (source pressure) for the hydraulic control device 9 is generated by the mechanical oil pump 21. Based on the generated hydraulic pressure, the hydraulic control device 9 supplies an engagement pressure for the hydraulic servo for the first clutch K0, an engagement pressure for the hydraulic servo for the second clutch C1, and the belt holding pressure of the continuously variable transmission 4.

In the description of the “forward travel mode by the internal combustion engine 2”, the vehicle is caused to travel using only output rotation (output torque) of the internal combustion engine 2. As a matter of course, however, the motor 3 may be subjected to power running control (assist) or regenerative control, and the vehicle may be caused to travel using output torque of the internal combustion engine 2 in combination with output torque of the motor 3.

Next, in a travel condition in which the shift signal 57 indicates the drive (D) range, the accelerator operation amount is small and a small drive force is required for the vehicle by the driver, and the vehicle speed is low such as when starting the vehicle, for example, a “forward travel mode by the motor 3” (that is, EV travel) is selected to control the internal combustion engine 2 into a stopped state, control the first clutch K0 into a disengaged state, control the second clutch C1 into an engaged state, and drivably control the motor 3 on the basis of the accelerator operation amount as illustrated in FIG. 2B.

That is, the input shaft 11 of the hybrid drive device 1 and the internal combustion engine 2 are in a stopped state, drive rotation of the motor 3 in the forward direction ω1 is transferred to the intermediate shaft 11 and further, drive rotation of the motor 3 in the forward direction ω1 is also transferred to the input shaft 4a of the continuously variable transmission 4 via the second clutch C1. Then, the rotation of the motor 3 input to the input shaft 4a of the continuously variable transmission 4 is varied in speed by the continuously variable transmission 4, which is controlled so as to have an optimum speed ratio on the basis of the vehicle speed and the accelerator operation amount, and transferred to the wheels 30 via the differential device 5 and the left and right axes 31, 31 to rotate the wheels 30 forward.

In the “forward travel mode by the motor 3”, the internal combustion engine 2 is stopped, the mechanical oil pump 21 is stopped with the input shaft 11 stopped, and therefore the electric oil pump 22 is driven so that the electric oil pump 22 generates a hydraulic pressure (source pressure) for the hydraulic control device 9. Based on the generated hydraulic pressure, the hydraulic control device 9 supplies an engagement pressure for the hydraulic servo for the second clutch C1 and the belt holding pressure if the continuously variable transmission 4.

In the “forward travel mode by the motor 3”, in the case where the drive force required by the driver which is based on the accelerator operation amount or the like becomes larger than the belt holding pressure of the continuously variable transmission 4 which is based on the maximum hydraulic pressure of that may be generated by the electric oil pump 22, that is, the maximum torque capacity that can be transferred by the continuously variable transmission 4, the control section 50 changes the selected mode to the “forward travel mode by the internal combustion engine 2” described above. This cause the belt holding pressure of the continuously variable transmission 4 to be raised by drive of the mechanical oil pump 21 which prevents belt slip in the continuously variable transmission 4.

During “forward travel mode by the motor 3”, the mechanical oil pump 21 is stopped, but a reverse flow of a hydraulic pressure from the electric oil pump 22 to the mechanical oil pump 21 is prevented by a check valve (not illustrated) or the like.

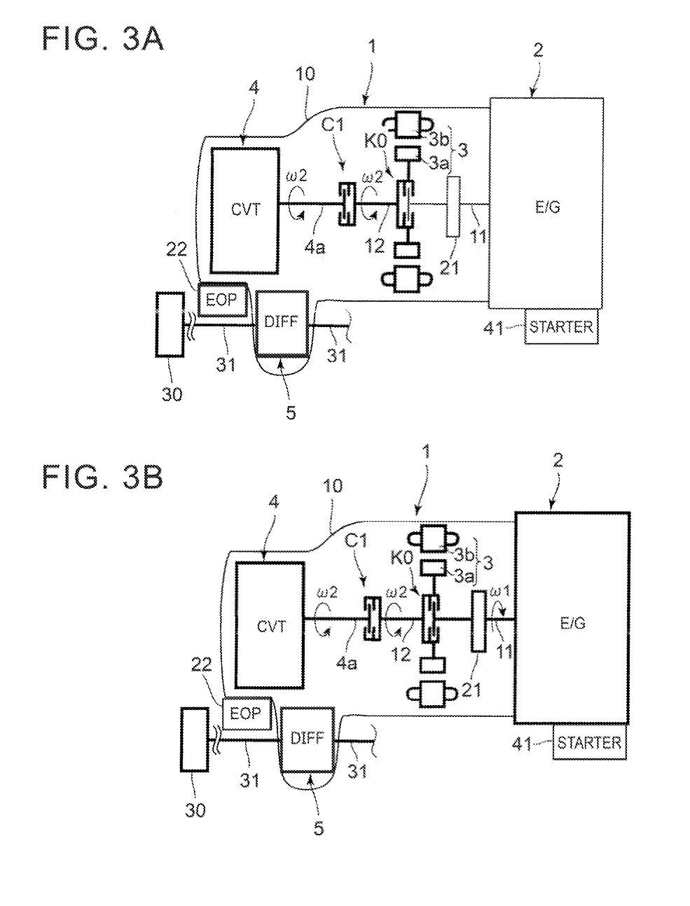

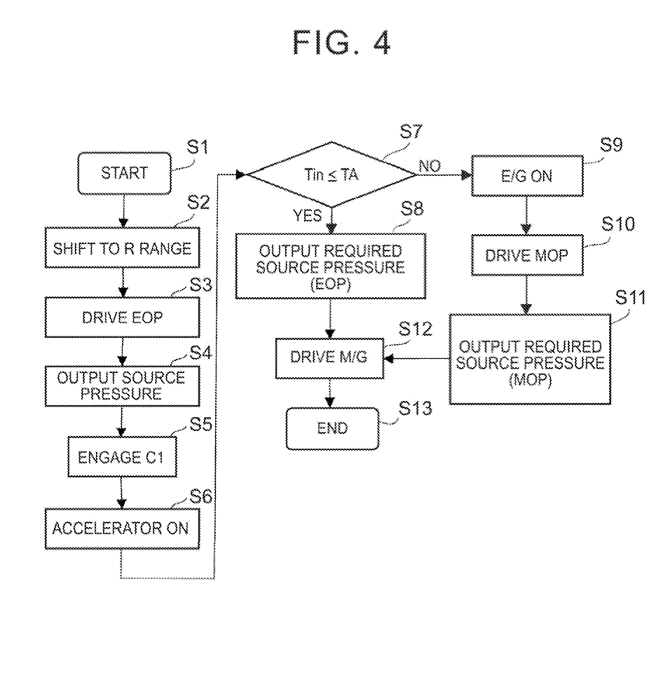

Subsequently, the modes during reverse travel of the hybrid drive device 1 will be described with reference to FIGS. 3 and 4. In the hybrid drive device 1, as discussed above, the continuously variable transmission 4 does not include a forward/reverse travel switching device, and reverse travel of the vehicle is enabled by drive output due to reverse rotation of the motor 3.

First, when the control section 50 starts control (S1), and the driver operates as shift lever to the R (reverse) range, for example, and the shift signal 57 indicates the reverse (S2), the control section 50 drives the electric oil pump 22 (S3), and starts supplying the minimum source pressure to the hydraulic control device 9 (S4). Subsequently, the control section 50 provides a command to the hydraulic control device 9 to engage the second clutch C1 by supplying an engagement pressure to the hydraulic servo fir the second clutch C1 (S5). This causes the motor 3 to be drivably coupled to the continuously variable transmission 4, the differential device 5, the left and right axes 31, 31, and the wheels 30 via the second clutch C1 as illustrated in FIG. 3A.

Then, when minute torque for creeping is output from the motor 3, for example, torque in the reverse direction ω2 is output from the motor 3 to the intermediate shaft 2, and further, drive rotation of the motor 3 in the reverse direction ω2 is also transferred to the input shah 4a of the continuously variable transmission 4 via the second clutch C1 as illustrated in FIG. 3A. Then, the rotation of the motor 3 input to the input shaft 4a of the continuously variable transmission 4 is varied in speed by the continuously variable transmission 4, which is controlled so as to have an optimum speed ratio on the basis of the vehicle speed and the accelerator operation amount, and transferred to the wheels 30 via the differential device 5 and the left and right axes 31, 31 to rotate the wheels 30 rearward.

Here, when the accelerator is depressed (turned on) by the driver (S6), for example, the control section 50 calculates the drive force required by the driver from the accelerator operation amount information 51 or the like, an determines whether or not input torque Tin input to the continuously variable transmission 4 (that is, output torque of the motor 3) is equal to or more than predetermined torque TA (S7). The predetermined torque TA is a torque capacity that can be transferred by the continuously variable transmission 4 and the second clutch C1 calculated from the belt holding pressure of the continuously variable transmission 4 and the torque capacity the second clutch C1, which are based on the maximum output hydraulic pressure from the electric oil pump. In short, the predetermined torque TA is a value at the boundary at which belt slip or clutch slip occurs or does not occur with only the hydraulic pressure generated by the electric oil pump 22.

If the control section 50 determines in step S7 described above that the input torque input to the continuously variable transmission 4 is less than the predetermined torque TA (YES in S7), the control section 50 provides a command to control an electric motor of the electric oil pump 22 with the internal combustion engine 2 kept stopped, and the electric oil pump (EOP) 22 outputs a source pressure that is necessary as the belt holding pressure of the continuously variable transmission 4 to the hydraulic control device 9 (S8) as illustrated in FIG. 3A.

Then, the control section 50 controls the motor (M/G) 3 in accordance with the accelerator operation amount or the like (S12), and the motor 3 outputs torque matching the required drive force and the continuously variable transmission 4 is controlled to an optimum speed ratio to cause the vehicle to travel in reverse, which terminates the control (S13).

If the control section 50 determines in step S7 described above that the input torque Tin input to the continuously variable transmission 4 is equal to or more than the predetermined torque TA (NO in S7), on the other hand, the control section 50 provides a command to the starter 41 to start the internal combustion engine 2 with the first clutch K0 kept disengaged (S9), and rotates the input shaft 1 in the forward direction ω1 to drive the mechanical oil pump 21 (S10), that is, starts the “mechanical oil pump drive mode” as illustrated in FIG. 3B.

That is, in the “mechanical oil pump drive mode”, the internal combustion engine 2 is started only to drive the mechanical oil pump 21 without affecting the drive rotation of the motor 3 in the reverse direction ω2 by disengaging the first clutch K0. This enables the mechanical oil pump 21 to output a source pressure that is necessary as the belt holding pressure of the continuously variable transmission 4 to the hydraulic control device 9 (S11).

Therefore, large torque that is equal to or more than the predetermined torque TA is output from the motor 3 (S12). The belt holding pressure is hydraulically controlled so as to be higher on the basis of the source pressure generated by the mechanical oil pump 21 even if the large torque that is equal to or more than the predetermined torque TA described above is input to the continuously variable transmission 4. Thus, the vehicle travels in reverse without belt slip caused in the continuously variable transmission 4 and with the continuously variable transmission 4 controlled to an optimum speed ratio, which terminates the control (S13).

During the “mechanical oil pun p drive mode”, when the source pressure output from the t mechanical oil pump 21 becomes higher than the source pressure output from the electric oil pump 22, the electric oil pump 22 is stopped, and a reverse flow of a hydraulic pressure from the mechanical oil pump 21 to the electric oil pump 22 is prevented by a check valve (not illustrated) or the like.

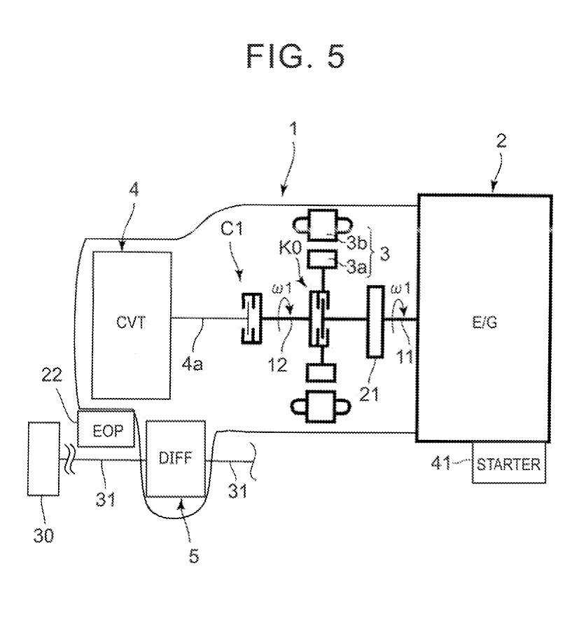

Subsequently, the “charge mode” of the hybrid drive device 1 will be described with reference to FIG. 5. As discussed above, the continuously variable transmission 4 does not include a forward/reverse travel switching device, and therefore in the case where reverse travel is to be performed by the hybrid drive device 1, reverse travel of the vehicle is enabled by drive output due to reverse rotation of the motor 3. Therefore, reverse travel may not be performed in the case where the battery remaining capacity is short.

Thus, in the case where the battery remaining capacity is short, the control section 50 selects the “charge mode” as illustrated in FIG. 5. When the “charge mode” is selected the first clutch K0 is controlled so as to be engaged and the second clutch C1 is controlled so as to be disengaged, and the internal combustion engine 2 is started to rotationally drive the input shaft 11, the intermediate shaft 12, and the rotor 3a of the motor 3 in the forward direction ω1. In this event, the motor 3 is subjected to regeneration control, and the battery is charged by the motor 3.

This allows charging to be performed while the vehicle is stationary (without traveling forward) even if the remaining charge capacity is short of a level that is required for reverse travel, which makes it possible to resume reverse travel thereafter.

In this event, the mechanical oil pump 21 is driven by drive of the input shaft 11. Thus, the engagement pressure for the first clutch K0 is secured on the basis of a hydraulic pressure generated by the mechanical oil pump 21.

In addition, adopting a configuration in which the motor is connected to a battery for auxiliaries (a so-called 12-V battery) via an inverter circuit and a step-down circuit (not illustrated) enables the battery for auxiliaries to be charged at the same time. This eliminates the need for auxiliaries for charge such as an alternator and a fan belt. As a matter of course, electric power may be supplied from the battery for drive of the motor 3 to the battery for auxiliaries via a step-down circuit.

As described above, in the hybrid drive device 1 which performs reverse travel using reverse rotation from the motor 3, the “mechanical oil pump drive mode” in which the mechanical oil pump 21 is driven using output rotation of the internal combustion engine 2 can be executed. Thus, a hydraulic pressure can be generated by drive of the mechanical oil pump 21 even during reverse travel. This reduces the design required hydraulic pressure to be output from the electric oil pump 22, which enables size reduction and cost reduction of the electric oil pump 22. This enables downsizing and cost reduction of the hybrid drive device 1.

In addition, the control section 50 executes the “mechanical oil pump drive mode” in the case where the input torque input to the continuously variable transmission 4 is equal to or more than the predetermined torque TA. Thus, in the case where the hydraulic pressure that is required for the continuously variable transmission 4 (for example, the belt holding pressure) is lower than a predetermined pressure, a hydraulic pressure is supplied by drive of the electric oil pump 22, which makes it possible to stop the internal combustion engine 2 and to improve the fuel efficiency of the vehicle. In the case where the hydraulic pressure that is required for the continuously variable transmission 4 (for example, the belt holding pressure) is higher than a predetermined pressure, meanwhile, the required hydraulic, pressure can be secured by drive of the mechanical oil pump 21 driven by the internal combustion engine 2.

In the embodiment described above, the continuously variable transmission 4 is a continuously variable transmission of a belt type. However, the present invention is not limited thereto, and the present invention may be applied to a continuously variable transmission of a toroidal type, for example. In the case of a continuously Variable transmission of a toroidal type, it is possible to secure a holding pressure for a power roller in a variator by supply of a required source pressure from the mechanical oil pump 21 and the electric oil pump 22, and slip of the power roller can be prevented by a hydraulic pressure from the mechanical oil pump 21 in the case where a hydraulic pressure from the electric it pump 22 is short.

In the embodiment, in addition, the mechanical oil pump 21 and the electric oil pump 22 are so-called oil pumps of a gear type. However, the present invention is not limited thereto, and the mechanical oil pump 21 and the electric oil pump 22 may Be oil pumps of a vane type, crescent oil pumps of a gear type, or the like. Further, it is considered that, among the oil pumps of a gear type, the mechanical oil pump 21 and the electric oil pump 22 may be internal or external oil pumps of a gear type.

### INDUSTRIAL APPLICABILITY

The hybrid drive device according to the present invention can he used for vehicles such as passenger ears and trucks, and is particularly suitable for use in vehicles for which downsizing and cost reduction are desired along with size reduction of an electric oil pump.

### DESCRIPTION OF THE REFERENCE NUMERALS

1 HYBRID DRIVE DEVICE
2 INTERNAL COMBUSTION ENGINE
3 ROTARY ELECTRIC MACHINE (MOTOR)
4 CONTINUOUSLY VARIABLE TRANSMISSION
4a INPUT SHAFT
9 HYDRAULIC CONTROL DEVICE
11 FIRST SHAFT (INPUT SHAFT)
12 SECOND SHAFT (INTERMEDIATE SHAFT)
21 MECHANICAL OIL PUMP
22 ELECTRIC OIL PUMP
30 WHEEL
50 CONTROL SECTION
C1 SECOND CLUTCH
K0 FIRST CLUTCH
TA PREDETERMINED VALUE (PREDETERMINED TORQUE)

1. A hybrid drive device characterized by comprising:
a first shaft drivably coupled to an internal combustion engine;
a mechanical oil pump driven in conjunction with the first shaft;
an electric oil pump driven independently of the mechanical oil pump;
a rotary electric machine;
a second shaft drivably coupled to the rotary electric machine;
a first clutch capable of blocking power transfer between the first shaft and the second shaft;
a continuously variable transmission capable of continuously varying a speed of rotation input to an input shaft and outputting to wheels rotation in the same direction as a direction of the rotation input to the input shaft;
a second clutch capable of blocking power transfer between the second shaft and the input shaft;
a hydraulic control device capable of hydraulically controlling the first clutch, the second clutch, and the continuously variable transmission using a hydraulic pressure generated by at least one of the mechanical oil pump and the electric oil pump; and
a control section capable of executing a mechanical oil pump drive mode in which a command to start the internal combustion engine is provided to drive the mechanical oil pump via the first shaft using output rotation of the internal combustion engine during reverse travel in which reverse rotation is output from the rotary electric machine to rotate the wheels in reverse via the second shaft, the second clutch, and the continuously variable transmission with the first clutch disengaged and with the second clutch engaged by providing a command to the hydraulic control device.

2. The hybrid drive device according to claim 1, wherein
the control section executes the mechanical oil pump drive mode in the case where input torque input to the continuously variable transmission is equal to or more than a predetermined value.

3. The hybrid drive device according to claim 2, wherein
the control section is capable of executing a charge mode in which charge is performed by driving the rotary electric machine via the first shaft, the first clutch, and the second shaft using output rotation of the internal combustion engine with the first clutch engaged and with the second clutch disengaged by providing a command to the hydraulic control device.

4. The hybrid drive device according to claim 1, wherein
the control section is capable of executing a charge mode in which charge is performed by driving the rotary electric machine via the first shaft, the first clutch, and the second shaft using output rotation of the internal combustion engine with the first clutch engaged and with the second clutch disengaged by providing a command to the hydraulic control device.
